(19) United States
(12) Patent Application Publication
(10) Pub. No.: US 2017/0152853 A1
(43) Pub. Date: Jun. 1, 2017

(54) MICRONIZING DEVICE OF INTEGRATED MILLING FUNCTION AND VANE SHEARING FUNCTION

(71) Applicant: EUREKA-LAB Inc., Shizuoka (JP)

(72) Inventor: Seiji KATAYAMA, Shizuoka (JP)

(21) Appl. No.: 15/312,862

(22) PCT Filed: May 20, 2015
(86) PCT No.: PCT/JP2015/064521

§ 371 Date: Nov. 21, 2016

(30) Foreign Application Priority Data
May 21, 2014 (JP) 2014-105679

(51) Int. Cl. F04D 7/04; F04D 29/22; B02C 19/10; B01F 5/12; B01F 3/12

(52) U.S. Cl. CPC F04D 7/045; B01F 5/12; B01F 3/12; B02C 19/10; F04D 29/2288; B01F 2215/0014; B01F 2215/0032

(57) ABSTRACT

A micronizing device including a positive displacement pump configured to rotate a vaned wheel from a side of a suction port of a case to a side of a delivery port of the case opposite to a partitioning wall, transport fluid to a rotation direction of the vaned wheel, pressure the fluid in a pump chamber which converges from the side of the suction port of the case to the side of the delivery port, and deliver the fluid from the delivery port of the case, and a side end surface reaching a vane from a boss portion of the vaned wheel and a side end surface of the partitioning wall of the case include grinding surfaces, and the sample is micronized by way of grinding caused by rotation of the vaned wheel and by way of shearing caused by the vane of the vaned wheel on these grinding surfaces.

### TECHNICAL FIELD

The present invention relates to a micronizing device which micronizes a sample.

### BACKGROUND ART

A wet micronization technique is indispensable in a manufacturing field such as food, drugs and chemical products. Further, the micronization technique is an indispensable element in the manufacturing field as part of a nanotechnology, too.

A near-future food processing technique, i.e., food processing of a higher added value needs the micronization technique at a submicron level. Japan is currently promoting agriculture as the senary industry, and processed food of agricultural products is gaining attention. To produce processed food of a higher added value, a higher micronization technique for food is demanded.

Conventional techniques and products related to micronization are classified into following 1) to 3).

1) An emulsification device which uses a shearing force produced by vane rotation

2) A colloid mill device which takes advantage of a grinding technique

3) A high pressure emulsification device which causes a sample to pass through a narrow nozzle by a high pressure

The respective devices have pros and cons in terms of the degrees of micronization (grain size), processing amounts, viscosity, processing temperatures, and homogeneity.

The emulsification device of 1) which uses the shearing force of the vanes enables a high throughput yet provides poor homogeneity and has difficulty in making a grain diameter less than 100 μm.

The colloid mill device of 2) enables refinement of a primarily-micronized sample at a micron level yet has difficulty in a high throughput and homogeneity.

A high pressure emulsification device of 3) enables micronization at a nano level yet has difficulty in a high throughput.

Further, these existing micronizing devices are generally large in case of business use, and are costly. Furthermore, single functions have been developed for the existing devices according to usages and according to functions, and therefore it is difficult to meet recent higher needs in various interdisciplinary fields. A situation is that business investment in sluggish economy expects introduction of low-cost and cost-effective devices which have various combined functions in single devices.

Meanwhile, pumps as functional parts support an industry foundation. An important usage of the pump is a liquid transporting function. In addition to this usage, another important usage which is micronization as described above is gaining attention.

The transporting function is used to discharge water for firefighting in the first place, and to transport various products such as chemical products and food. Meanwhile, devices having the micronizing function are juicers, mixers and, in addition, food processors which are not in a scope of the pump yet are devices which perform micronization by high speed vane rotation. Developed micronizing devices of this micronizing method are placed on the market as a colloid mill (Mountech Co. Ltd in Germany), a supermasscollider (registered trademark: MASUKO SANGYO CO., LTD.) and a comitrol (registered trademark: Urschel Laboratories, Inc. in the U.S.A.). However, every device depends on a shearing force produced by vane rotation caused by a motor.

The inventor of the invention has already developed a micronization pump system which has stirring, centrifuging, compressing, shearing and cavitating functions by combining a high pressure centrifugal pump in which gas can be mixed and a microbubble generating device (Patent Literature 1).

### CITATION LIST

### Patent Literature

Patent Literature 1: International Publication No. 2011/049215

### SUMMARY OF INVENTION

### Technical Problem

However, this pump system enables large-volume micronization processing at several tens of the micron level with respect to highly viscous samples yet has limited performance for micronization at the submicron level similar to the existing devices.

A micronizing technique at the submicron level is indispensable to achieve a near-future food processing technique, i.e., food processing of a higher added value.

The present invention has been made in light of the above-described situation, and an object of the present invention is to provide a micronizing device which enables micronization (refinement) in a large dynamic range from a large grain diameter of several tens of millimeters to a grain diameter of submicrons in one device.

### Solution to Problem

To achieve the above-described object, a micronizing device of the present invention is a micronizing device which micronizes a sample including:

a vaned wheel; and a case which houses the vaned wheel, and includes a suction port which suctions in a pump chamber a fluid including the sample to be micronized, and a delivery port which delivers the fluid to an outside of the pump chamber, wherein

the vaned wheel includes a vane plate of a disk shape, a boss portion which pivotally supports rotatably on the case the vaned wheel provided at a center portion of the vane plate, and a plurality of vanes which protrudes in a radial pattern from the boss portion on a side surface of the vane plate, and includes a side end surface flush with the boss portion,

the case includes an inner circumferential surface of a cylindrical shape which houses the vaned wheel along an outer circumferential portion of the inner circumferential surface, and a pressuring portion which faces the vane of the vaned wheel housed in the case,

the pressuring portion includes a pressuring surface which faces the vane of the vaned wheel housed in the case, where the pump chamber which converges from a side of the suction port of the case to a side of the delivery port is formed between the pressuring surface and the vaned wheel, and a partitioning wall which partitions the pressuring surface to the side of the suction port of the case and a side at which the pump chamber converges, and includes a side end surface which comes into contact with a side end surface reaching the vane from the boss portion of the vaned wheel,

the positive displacement pump is configured to rotate the vaned wheel from the side of the suction port of the case to the side of the delivery port of the case opposite to the partitioning wall, transport the fluid including the sample to a rotation direction of the vaned wheel, pressure the fluid including the sample in the pump chamber which converges from the side of the suction port of the case to the side of the delivery port, and deliver the fluid through the delivery port of the case, and

a side end surface reaching the vane from the boss portion of the vaned wheel and a side end surface of the partitioning wall of the case include grinding surfaces, and the sample is micronized by way of grinding caused by rotation of the vaned wheel and by way of shearing caused by the vane of the vaned wheel on the grinding surfaces.

### Advantageous Effects of Invention

According to the present invention, a micronizing device of integrated micronizing function and milling (grinding) function which uses a shearing force produced by vane rotation enables micronization in several tens of millimeters to submicrons in one device without performing micronization stepwise. It is possible to perform circulation-type processing by using a pump, so that the micronizing device can perform processing multiple times, provides good homogeneity and good operability, enables mass production in a short time and is very cost-effective. Thus, the micronizing device enables micronization in several tens of millimeters to submicrons and, consequently, contributes to creation of a new processing technique.

### BRIEF DESCRIPTION OF DRAWINGS

FIG. 1 is a side view of a pressuring portion side illustrating a pressuring member used in a micronizing device according to an embodiment of the present invention.

FIG. 2 is a perspective view of the pressuring portion side illustrating the pressuring member used in the micronizing device according to the embodiment of the present invention.

FIG. 3 is a perspective view of a suction pipe side illustrating the pressuring member used in the micronizing device according to the embodiment of the present invention.

FIG. 4 is a side view of a vane side illustrating a vaned wheel used in the micronizing device according to the embodiment of the present invention.

FIG. 5 is a perspective view of the vane side illustrating the vaned wheel used in the micronizing device according to the embodiment of the present invention.

FIG. 6 is an exploded perspective view illustrating a case structure in the micronizing device according to the embodiment of the present invention.

FIG. 7 is a side view illustrating the partially broken micronizing device according to the embodiment of the present invention.

FIG. 8 is a sectional view illustrating a configuration of a pump chamber of the micronizing device according to the embodiment of the present invention.

FIG. 9 is a sectional view illustrating a configuration of the pump chamber of the micronizing device according to another embodiment of the present invention.

FIGS. 10(A) to 10(C) are charts illustrating results of an example of micronization of Japanese mugwort obtained by using the micronizing device according to the present invention.

FIG. 11 is a chart illustrating a result of the example of micronization of coffee grounds obtained by using the micronizing device according to the present invention.

FIG. 12 is a chart illustrating a result of the example of micronization of activated carbon obtained by using the micronizing device according to the present invention.

FIG. 13 is a chart illustrating a result of the example of micronization of green tea obtained by using the micronizing device according to the present invention.

FIG. 14 illustrates a pump head-to-discharge amount curve of a pump system of the micronizing device according to the example.

FIG. 15 illustrates pump head-to-discharge amount curves of a pump system configured by the micronizing device which uses positive displacement vanes according to the example, and pump systems configured by micronizing devices which use centrifugal vanes and intermediate vanes of the positive displacement vanes and the centrifugal vanes.

### DESCRIPTION OF EMBODIMENTS

An embodiment of the present invention will be described with reference to the drawings below.

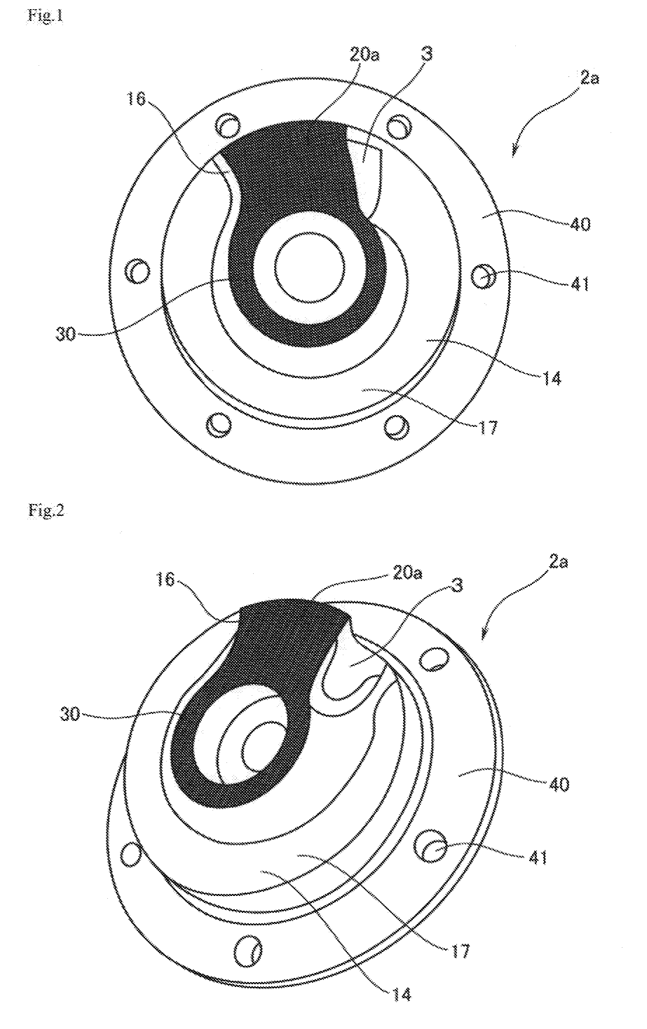

FIGS. 1 to 8 illustrate a micronizing device according to the embodiment of the present invention.

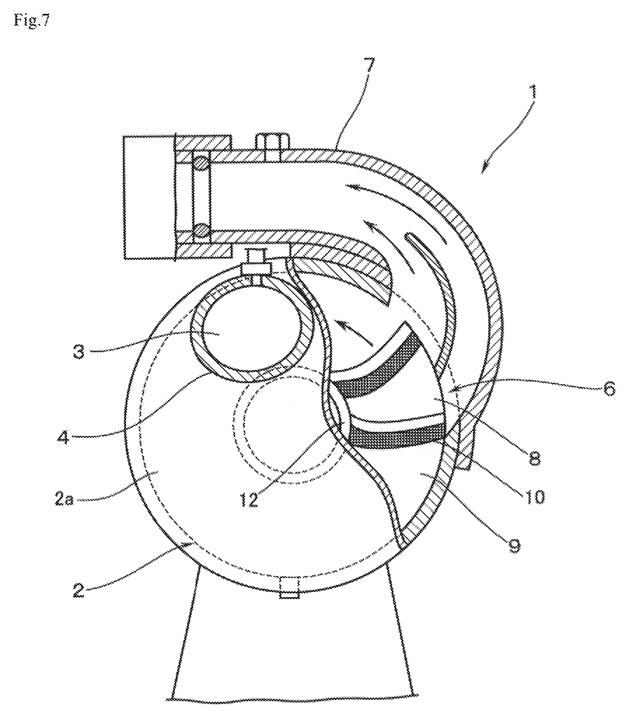

As illustrated in FIG. 7, a micronizing device 1 includes a vaned wheel 8 and a case 2 which houses this vaned wheel 8.

The case 2 includes a pressuring member 2a of a lid shape and a case main body 2b of a drum shape, and this case 2 is formed by a pair of the left pressuring member 2a of the lid shape including a suction port 3, and the right vaned wheel case 2b including a delivery port 6.

The pressuring member 2a of the case 2 includes the suction port 3 which suctions a fluid including a sample to be micronized, and the case main body 2b which houses the vaned wheel 8 includes the delivery port 6 which delivers this fluid.

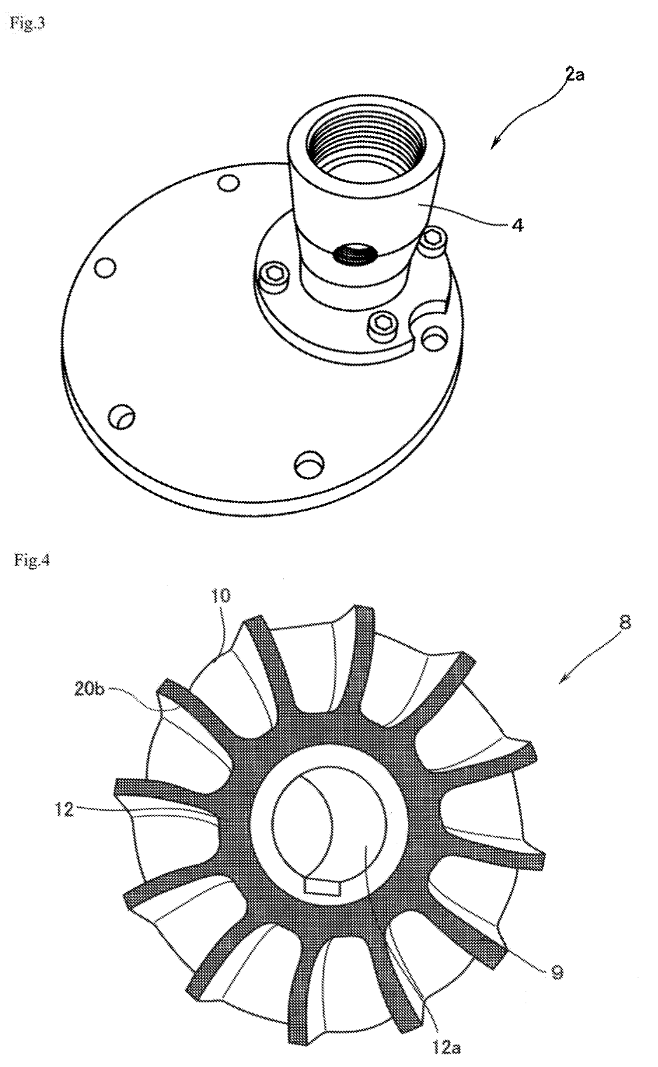

This pressuring member 2a has a shape which serves as a lid of the case main body 2b, and includes a suction pipe 4 which introduces the sample to be micronized, on a surface which is an outer side of the case 2 as illustrated in FIG. 3. As illustrated in FIGS. 1 and 2, the suction port 3 which continues from the suction pipe 4 and introduces the sample to be micronized, into the case 2 is provided on the surface at a side opposite to the suction pipe 4.

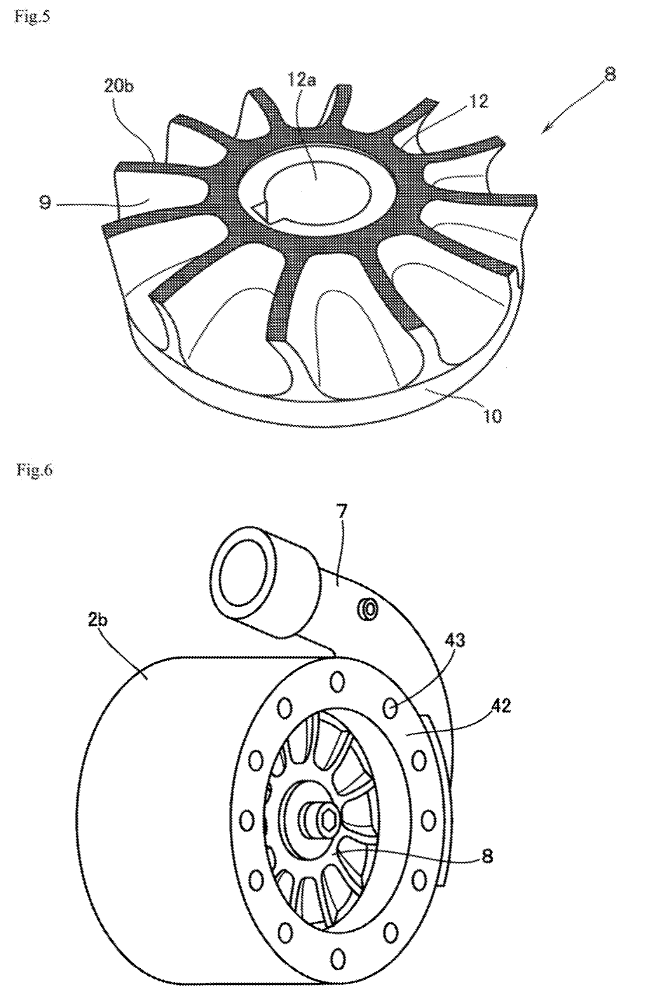

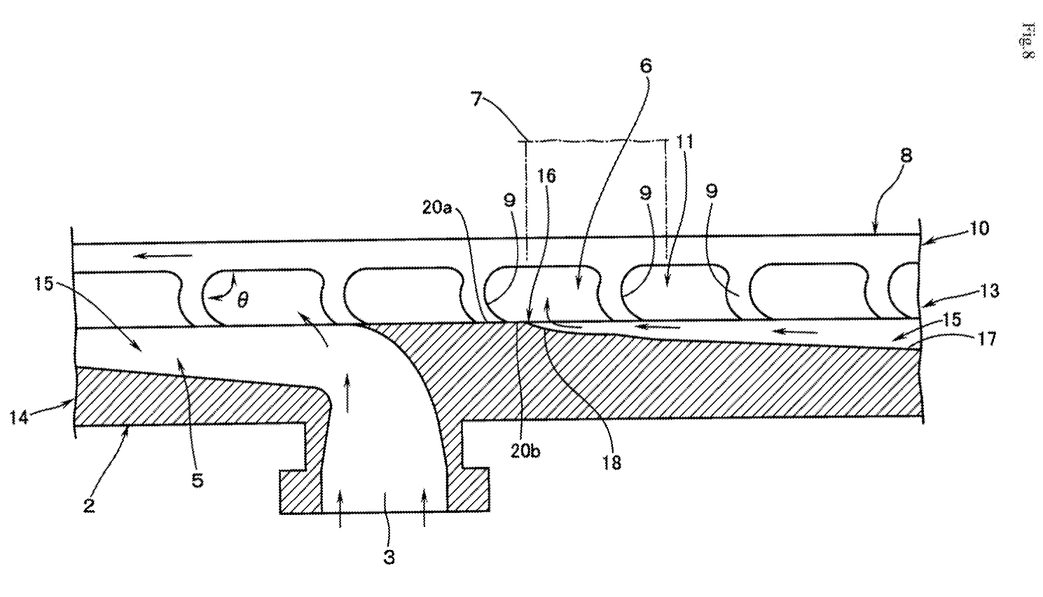

Further, the pressuring member 2a includes a pressuring portion 14 on a surface at the side opposite to the suction pipe 4 as illustrated in FIGS. 1 and 2. This pressuring portion 14 includes a pressuring surface 17 where a pump chamber 13 in FIG. 8 which faces vanes 9 of the vaned wheel 8 housed in the case 2, and converges from a side of the suction port 3 of the case 2 to a side of the delivery port 6 is formed between the pressuring surface 17 and the vaned wheel 8, and a partitioning wall 16 which partitions this pressuring surface 17 to the side of the suction port 3 of the case 2 and the side at which the pump chamber 13 converges, and includes a side end surface (grinding surface 20b) which comes into contact with a side end surface (grinding surface 20a) reaching the vanes 9 from a boss portion 12 of the vaned wheel 8 in FIG. 4.

Further, a connection surface 40 which is formed in an annular plane for connecting with the case main body 2b to be sealed from the outside is provided along an outer circumferential portion closer to the outer side than the suction port 3.

At an inner side of the annular connection surface 40, the pressuring surface 17 which protrudes from the connection surface 40 such that the sample to be micronized is pressured between the pressuring surface 17 and the vaned wheel 8, and the partitioning wall 16 which partitions this pressuring surface 17 are formed.

The partitioning wall 16 is formed protruding from the pressuring surface 17 in a range from a center portion of the pressuring member 2a to the connection surface 40, and the side end surface of the partitioning wall 16 is the grinding surface 20a which continues to the connection surface 40 from a contact surface 30 of a roughly annular shape which comes into contact with the boss portion 12 of the vaned wheel 8.

The pressuring surface 17 is an inclined surface which gradually inclines from the suction port 3 provided at one side of the partitioning wall 16 to a side opposite to the suction port 3 of the partitioning wall 16 between the partitioning wall 16 and the connection surface 40.

As illustrated in FIGS. 4 and 5, the vaned wheel 8 includes a vane plate 10 of a disk shape, the boss portion 12 which pivotally supports rotatably on the case main body 2b the vaned wheel 8 provided at a center portion of this vane plate 10, and a plurality of vanes 9 which protrudes in a radial pattern from the boss portion 12 on a side surface of the vane plate 10, and includes a side end surface flush with the boss portion 12.

The vaned wheel 8 of an impeller shape is formed by integrally forming the boss portion 12 of a cylindrical shape which functions as an attachment member for a pump shaft, too, with a center portion of the vane plate 10 of a disk shape which is a vane sidewall.

Further, each vane 9 is protruded in the radial pattern at predetermined intervals from the vane plate 10 and the boss portion 12, and a space portion formed by each vane 9, the vane plate 10 and the boss portion 12 is a vane chamber 11 in FIG. 8 which engulfs the sample to be micronized.

The vaned wheel 8 is formed flush with the side end surfaces of the boss portion 12 and the vanes 9, and comes into contact with the contact surface 30 which is the side end surface of the partitioning wall 16 with the side end surface of the boss portion 12 formed at the center portion of the pressuring member 2a when the vaned wheel 8 is attached to the case main body 2b.

As illustrated in FIGS. 4, 5, and 7, the vanes 9 of this vaned wheel 8 are protruded in a radial direction on one side surface of the vane plate 10 of the disk shape and from the boss portion 12 to a lower side in a rotation direction of the vaned wheel 8, and have vane pieces which have flat shapes when seen from a side view and are bent inclining forward at intermediate portions of the lengths of the vane pieces. That is, the vanes 9 of the vaned wheel 8 are bent such that a distal end side of the vanes 9 in a length direction on the side end surface warps inclining forward in the rotation direction of the vaned wheel 8.

Further, a vane surface is formed inclining at a sweepback angle θ toward an upper side in the rotation direction of the vaned wheel 8 as illustrated in FIG. 8 such that an outer side end surface (thickness end) of the vanes 9 at the side of the pressuring member 2a is recessed from a base portion side of the vane plate 10. Alternatively, in other embodiments, the vane surface may be formed inclining at the forward-inclining angle θ toward the lower side in the rotation direction of the vaned wheel 8 as illustrated in FIG. 9 such that the outer side end surface (thickness end) of the vanes 9 at the side of the pressuring member 2a protrudes compared to the base portion side of the vane plate 10. Alternatively, although not illustrated, the outer side end surface (thickness end) of the vanes 9 at the side of the pressuring member 2a may be formed upright (such that 8 becomes approximately 0) without inclining from the base portion side of the vane plate 10.

This vane shape makes it easy to scrape the fluid including the sample through the suction port 3 accompanying rotation of the vaned wheel 8, and holds the fluid in each vane chamber 11 in FIG. 8. Further, each vane 9 pushes the fluid in each vane chamber 11 to an outside through the delivery port 6 by the forward-inclined vane shape when reaching a site of the delivery port 6.

As illustrated in FIGS. 6 and 7, an outer circumference of the sidewall of the disk shape of the case main body 2b is integrally formed with a surrounding wall having the width which allows the vaned wheel 8 and the pressuring portion 14 of the pressuring member 2a fitted therein. As illustrated in FIG. 6, the case main body 2b houses the vaned wheel 8 on the inner circumferential surface of the cylindrical shape and along an outer circumferential portion of the inner circumferential surface.

As illustrated in FIG. 7, the delivery port 6 having a predetermined length over a plurality of vanes 9, 9 . . . is bored at a predetermined site of the surrounding wall of the case main body 2b facing a vane width of the vaned wheel 8. Further, a delivery pipe 7 curved in a fluid delivery direction integrally continues to the delivery port 6.

A support portion is integrally jointed to an outer side of a sidewall of the pressuring member 2a to position the pump shaft at a center portion of the pump chamber 13 to rotatably support. As illustrated in FIG. 6, the pressuring surface 17 (pressuring portion 14) of the pressuring member 2a is fitted in an opening portion of the case main body 2b to which the vaned wheel 8 is assembled, fixing holes 41 of the connection surface 40 of the pressuring member 2a and fixing holes 43 of a connection surface 42 of the case main body 2b are fastened and fixed by fixing tools so as to configure the case 2 in a closed shape as illustrated in FIG. 7.

Thus, as illustrated in FIG. 8, the pump chamber 13 which pressures via the vaned wheel 8 the sample which has been suctioned through the suction port 3 and which is to be micronized, and delivers the sample through the delivery port 6 is formed between the pressuring surface 17 (pressuring portion 14) and the vaned wheel 8.

The vaned wheel 8 is housed in the case main body 2b without a gap at cutting precision with a clearance of 50μ. This case main body 2b includes the grinding surfaces 20a and 20b having a milling function described below to enable micronization. A size of the micronizing device 1 which functions as a pump can be selected based on the radius of the vaned wheel 8 (large size: φ120 mm, middle size: 100 mm and small size: 5 mm).

An operation of the micronizing device will be described with reference to FIG. 8. As illustrated in FIG. 8, the pump chamber 13 includes a suction chamber 5 which facilitates the fluid to be suctioned, and a pressuring chamber 15 which continues to the suction chamber 5 and pressures the fluid.

Further, the partitioning wall 16 which comes into contact with the side end surfaces of a plurality of vanes 9 is formed flush between an end of the pressuring chamber 15 and the suction port 3 such that the partitioning wall 16 continues from the contact surface 30 with the boss portion 12 of the roughly annular shape to the connection surface 40. Thus, the suction chamber 5, the pressuring chamber 15 and the partitioning wall 16 are continuously formed around the contact surface 30 of the roughly annular shape facing the side end surface of the boss portion 12 of the vaned wheel 8.

Further, on the pressuring surface 17 formed as a smooth inclined surface in a range from the side of the suction port 3 to the partitioning wall 16, the pressuring chamber 15 which becomes gradually closer to the vanes 9 from the side of the suction chamber 5 is formed in a converged shape. Thus, the fluid including the sample suctioned in the pump chamber 13 through the suction port 3 is gradually pressured by a plurality of vanes 9 via the pressuring chamber 15 which is a long passage in a state where the fluid is successively scraped and held in each vane chamber 11 by rotation of the vaned wheel 8.

The pressuring surface 17 is formed to a pressuring end point 18 positioned at a side opposite to the suction port 3 of the partitioning wall 16, and pressures and induces the fluid to be transported from the suction chamber 5 to a downstream side, into each vane chamber 11 along the pressuring surface 17. Further, the pressuring surface 17 pressures the fluid without rapidly fluctuating a pressure on the fluid in the pump chamber 13, and efficiently pushes out through the delivery port 6 the fluid pressured at a maximum pressure at a position of the pressuring end point 18.

When one side of the pump shaft is driven by a side of a motor to drive and rotate the vaned wheel 8 in an arrow direction, each vane 9 scrapes and suctions the fluid and air in each vane chamber 11 through the suction port 3, and continuously causes in turn the fluid to reach the pump chamber 13 in a state where the fluid is contained in each vane chamber 11. Further, the fluid and air bubbles in the pressuring chamber 15 are pressured along the pressuring surface 17, enter the vane chambers 11 while being pressured more, and reach the partitioning wall 16 in a maximum pressured state, are applied a pushing force by the shape of the pressuring surface 17 and rotation of the vanes 9 and are delivered through the delivery port 6.

Thus, a positive displacement pump is configured to rotate the vaned wheel 8 from the side of the suction port 3 of the case 2 to the opposite side to the partitioning wall 16, i.e., to the side of the delivery port 6 of the case 2, transport the fluid including the sample to the rotation direction of the vaned wheel 8, and cause the pump chamber 13 which converges from the side of the suction port 3 of the case 2 to the side of the delivery port 6 to pressure the fluid including the sample to deliver the fluid through the delivery port 6 of the case 2.

That is, a clearance between the case main body 2b and the vanes 9 is minimized. Therefore, the positive displacement pump is configured by a mechanism that the vanes 9 are arranged without a gap in the case main body 2b, the fluid entering between fins of the vanes 9 through the suction port 3 is pushed up in the pressuring portion 14 which composes a compression flow path and finally fly out of the delivery port 6.

Generally, pumps whose vanes (blades or fins) rotate in pump cases are classified into a centrifugal pump and a positive displacement pump. The centrifugal pump includes a gap between a space and rotation vanes in the pump case, and functions to move a liquid entering this gap, to an outside by a centrifugal force caused by vane rotation. When the vane ration is changed from a low speed to a high speed, the vane rotation and the liquid in the gap move in synchronization in case of the low speed. A pump head-to-discharge amount curve of the pump in this case shows a proportional relationship. However, in case of high speed vane rotation, the vane rotation and the liquid in the gap do not move in synchronization and delay. This delay appears as a plateau curve which is saturated on the pump head-to-discharge amount curve of the pump. All pump performances of volute pumps such as a cascade pump and a sanitary pump indicate such a pattern.

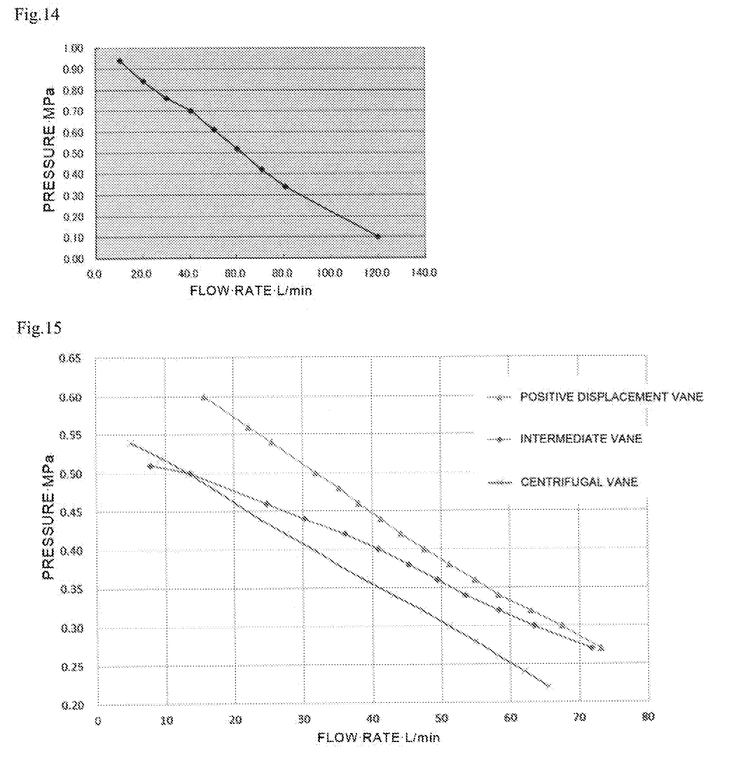

The pump configured by the micronizing device 1 seems to be a centrifugal volute pump from a viewpoint that the vanes (vaned wheel 8) rotate in the pump case (the case 2 or the case main body 2b). However, as illustrated in FIG. 14, the pump head-to-discharge amount curve of the pump configured by the micronizing device 1 made in the following example maintains a linear relationship with respect to a change from a discharge amount in case of low speed rotation to a discharge amount in case of high speed rotation, and the plateau does not appear. This result (curve pattern) suggests that the pump configured by the micronizing device 1 is not the centrifugal pump but the positive displacement pump. This is because the clearance of this pump is very small, there is little gap between the pump case (the case 2 and the case main body 2b) and the rotation vanes (vaned wheel 8), and only the liquid engulfed in blades or fins of the vanes influences the pump head-to-discharge amount curve. Therefore, it is understood that, even when the number of times of vane rotation increases, the pump head-to-discharge amount curve indicates the discharge amount, i.e., the pump head proportional to the number of times of vane rotations.

Further, the micronizing device 1 includes the grinding surfaces 20a and 20b on the side end surface of the partitioning wall 16 of the case 2 and the side end surface reaching the vanes 9 from the boss portion 12 of the vaned wheel 8, and micronizes the sample by way of grinding caused by rotation of the vaned wheel 8 and by way of shearing caused by the vanes 9 of the vaned wheel 8 on these grinding surfaces 20a and 20b.

That is, to achieve the micronization technique at the submicron level, grooves are dug in surfaces in planar contact between the vaned wheel 8 and the pressuring member 2a of the lid shape to allocate the milling function for grinding. The milling function is provided by allocating a grinding function in a plane between the grinding surface 20a of the pressuring member 2a and the grinding surface 20b of the vaned wheel 8. This grinding function is achieved by cutting the side end surface of the partitioning wall 16 of the case 2 and the side end surface reaching the vanes 9 from the boss portion 12 of the vaned wheel 8, and performing grinding surface (rough surface) processing such as a sesame mortar or a millstone.

It is possible to cut the cast vaned wheel 8 and pressuring member 2a and cut grooves variously designed in the grinding surfaces. Grooves whose widths are 0.5 to 1.5 mm and whose depths are 0.5 to 1.5 mm are variously designed and precisely cut in the side end surface of the partitioning wall 16 of the case 2 and the side end surface of the vaned wheel 8. A groove interval is, for example, 0.5 to 1.5 mm, and is cut at 90 degrees or 60 degrees to apply the grinding surface (rough surface) processing in a lattice pattern.

In a preferred aspect, the grinding surfaces 20a and 20b include grooves of the lattice patterns which are formed by way of cutting and have the above-described widths, depths and intervals.

The grinding surfaces 20a and 20b tend to be more effective for micronization when a cutting width and a cutting interval are narrower, and a groove depth of approximately 1 mm is suitable to a micronization effect in particular. An experiment conducted by forming the grinding surfaces 20a and 20b whose cutting width and cutting interval are 1 mm and whose groove depth is 1 mm shows that it has been possible to perform micronization at a nano level up to 80 nm. Compared to micronization performed at 1 μm at maximum by a conventional emulsification device, it has been possible to obtain an excellent micronization effect.

Micronization needs to be performed by cutting the case 2 and the vaned wheel 8 and taking into account a strength, an abrasion resistance and a chemical resistance of a material of the grinding surfaces 20a and 20b having the milling function. To secure the strength, the abrasion resistance and the chemical resistance, a material such as stainless steel SUS316, SUS316L or SCR10 or titanium can be selected.

The grinding (milling) effect heavily depends on a distance between contact surfaces of the vaned wheel 8 and the pressuring member 2a. An inter-surface distance (clearance) depends on cutting precision and is, for example, 5/100 mm. By digging grooves in the surfaces in planar contact between the vaned wheel 8 and the pressuring member 2a and designing the milling function for grinding, a micronizing function such as a millstone is designed to configure the micronizing device 1 of the integrated vane sharing function and milling function. By cutting the groove between the vaned wheel 8 and the pressuring member 2a planarly facing each other, i.e., by applying rough surface processing to surfaces as the grinding surfaces such as a millstone to minimize the clearance, it is possible to realize micronization at the nano level, too, which has been conventionally impossible.

The micronizing device 1 can configure a circulating pump by connecting the suction pipe 4 and the delivery pipe 7 of the case 2 to a circulating portion such as a circulating portion disclosed in Patent Literature 1. The micronizing device 1 can be attached to a conventionally known emulsification pump system device and can be operated as conventionally known.

The micronizing device 1 can construct a circulating milling function equipped micronization pump system, can perform processing multiple times by a circulating system since the pump portion performs micronization, and, consequently, improves a micronization effect.

Operation conditions of the micronizing device 1 are not limited in particular. Use of a three-phase 200 V motor and a grinding effect (milling effect) of the vaned wheel 8 which rotates at a high speed, i.e., rotates at 60 Hz, and 3600 rps, for example, and the pressuring member 2a can achieve micronization at the submicron level. A rotation speed of the vaned wheel 8 can be selected in a range of 0 to 5000 rps by selecting a frequency of an inverter, for example.

The micronizing device according to the present invention is a device formed by combining the vane shearing function and the milling function, and therefore is a device formed by integrating a homogenizer and a colloid mill. One device enables micronization from millimeters to microns and to submicrons, so that it is possible to remarkably improve micronization performance, provide good homogeneity and enable mass production in a short time. Further, the micronizing device not only has a good micronizing function but also is compact, has good functionality and operability, and is very cost-effective. That is, when micronization is performed by using the micronizing device according to the present invention, it is possible to omit one or two processes compared to a case where the homogenizer or the colloid mill are used, and reduce cost. Thus, it is possible to provide the micronization device which has not been able to be realized by a homogenizer or a colloid mill device of the conventional emulsification device alone.

It can be expected that enabling micronization in submicrons which has been conventionally impossible creates new processed food. By assembling the micronizing device according to the present invention as a circulating pump system, it is possible to remarkably improve processing operability and increase an added value, too.

Micronization target samples of the micronizing device according to the present invention can be grains, seeds, beans, fruits, vegetables and soft bones other than metals. The micronizing device according to the present invention paves a way for mud micronization processing, grounds micronization processing, effective use of grounds, micronization extraction, effective use of nanobubbles, micronization chemical reactions, and effective use thanks to micronization such as accelerated absorption of poorly soluble drugs.

The micronizing device according to the present invention is suitable to refine fluids including the above-described samples and, more particularly, refine samples under wet conditions using liquids in particular.

It is expected that the micronizing device according to the present invention paves a new way for micronization of food such as vegetables and fruits which has been conventionally difficult, and effective use of processed food grounds (tea leaves, tofu refuse, coffee grounds, orange peels, camellia oil draffs, perilla herb and seaweeds). For example, the micronizing device can introduce new processing methods (emulsification, puree and pasting) of fruits and foodstuff. According to the study conducted by the inventor of the invention, it has become obvious that, in fields other than food processing, too, the micronizing device according to the present invention is effective to disperse aggregated carbon nanotubes or activated carbon.

### EXAMPLE

The present invention will be further described in more detail below in the example. However, the present invention is not limited to this example.

The micronizing device according to the present invention was made. Stainless steel was used for a case, and grooves whose widths were 0.5 to 1.5 mm and whose depths were 0.5 to 1.5 mm were precisely cut in a side end surface of a partitioning wall of a pressuring member and a side end surface of a vaned wheel at intervals of 0.5 to 1.5 mm to form grinding surfaces (rough surfaces) composed of the grooves of lattice patterns. The grinding surfaces are in planar contact with each other at 5/100 mm of an inter-surface distance (clearance).

A three-phase 200 V motor was used to drive the vaned wheel, and a vane rotation speed was normally operated in a standard state of 60 Hz and 3600 rps by selecting a frequency of an inverter.

A pump system was configured by connecting a suction pipe and a delivery pipe of the case of the micronizing device to a circulating portion disclosed in Patent Literature 1.

In addition, in case of a pump head-to-discharge amount curve of a centrifugal pump, a pump head is generally known to come to a plateau even if a discharge amount is narrowed. By contrast with this, in case of a positive displacement pump, the pump head is known to linearly increase as the discharge amount decreases. However, a pump head-to-discharge amount of the pump system configured by this micronizing device was measured under air injection (microbubbles were produced by a configuration in Patent Literature 1) conditions by using tap water, and a result classified into the positive displacement pump was obtained as illustrated in FIG. 14. Further, the pump head-to-discharge amount curves of the pump system configured by the micronizing device according to this example which used positive displacement vanes, a pump system configured by a micronizing device which used centrifugal vanes and a pump system configured by a micronizing device which used intermediate values of the positive displacement vanes and the centrifugal vanes were compared. According to the micronizing device according to this example, the vanes of the vaned wheel were bent such that a distal end side of the vanes in a length direction warps inclining forward on a side end surface in a rotation direction of the vaned wheel to configure the positive displacement vanes. Meanwhile, according to the micronizing device which used the centrifugal vanes, the vanes of the vaned wheel were bent such that a distal end side of the vanes in the length direction warps inclining backward on the side end surface in a direction opposite to the rotation direction of the vaned wheel to configure the centrifugal vanes. According to the micronizing device which used the intermediate vanes of the positive displacement vanes and the centrifugal vanes, bent shapes of the vanes of the vaned wheel at a distal end side in the length direction on the side end surface have intermediate shapes of the positive displacement vanes and the centrifugal vanes. FIG. 15 illustrates a result obtained by measuring the pump head-to-discharge amount curves by using the pump systems configured by these micronizing devices. An obvious difference in the pump head-to-discharge amount curves between the micronizing device according to this example classified into the positive displacement pump, and the micronizing device which used the centrifugal vanes and the micronizing devices which used the intermediate vanes of the positive displacement vanes and the centrifugal vanes was confirmed. In addition, attention needs to be paid to that, when the same positive displacement pump is used, a pump head-to-discharge amount characteristic curve differs according to performance of a microbubble generating device used in combination.

Wet micronization tests were conducted on Japanese mugwurt, coffee grounds, active carbon and green tea as the samples by using the pump systems configured by this micronizing devices.

A grain diameter distribution of the samples before and after micronization was measured by using LA-950 made by HORIBA, Ltd.

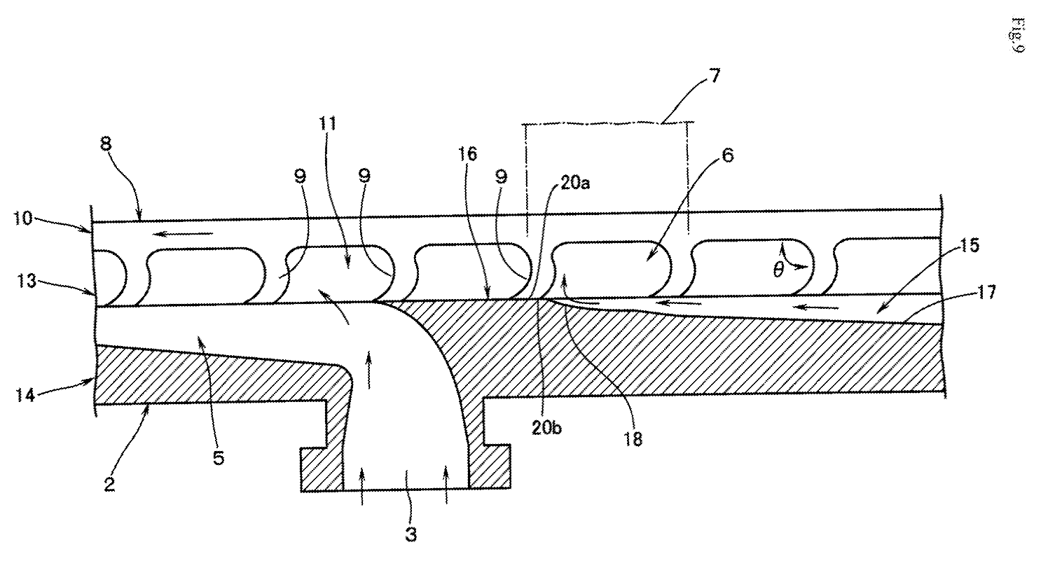

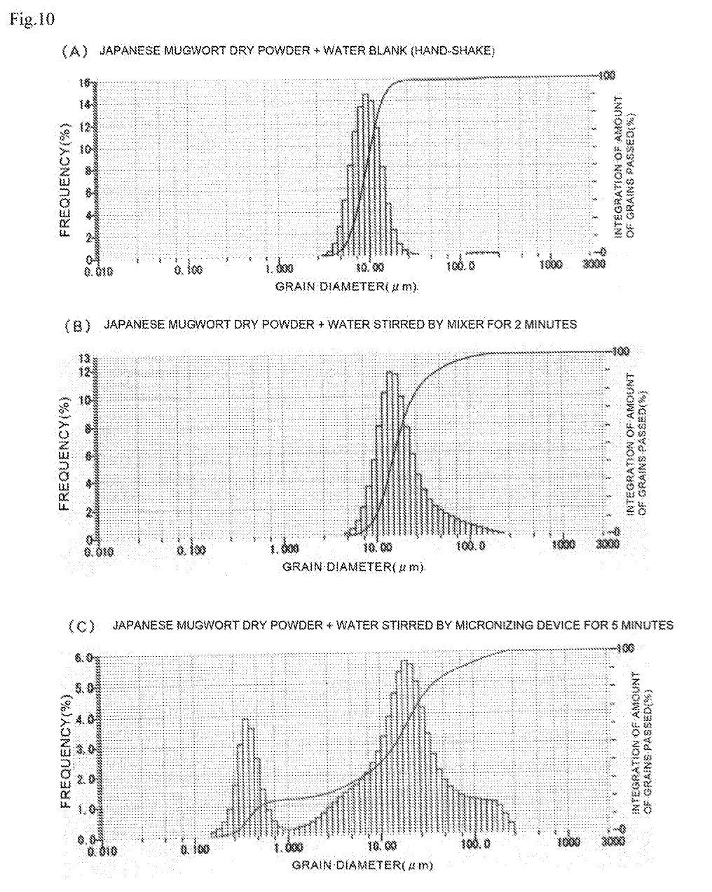

FIGS. 10(A) to 13 illustrate test results.

FIGS. 10(A) to 13 show that the samples processed by the micronizing devices had decreased large grain diameter components and increased small grain diameter components and it was possible to perform micronization at the submicron level.

FIG. 10(A) illustrates a grain diameter distribution of a sample obtained after using Japanese mugwort dry powder as the sample, and putting the sample in the case with water and mixing the sample and the water by hand-shaking. FIG. 10(B) illustrates a grain diameter distribution of a sample obtained after stirring the sample and water by a mixer for two minutes. FIG. 10(C) illustrates a grain diameter distribution of a sample obtained after stirring the sample and the water by the micronizing device for five minutes. FIG. 10(C) shows that the sample processed by using the micronizing device had decreased large grain diameter components and increased small grain diameter components.

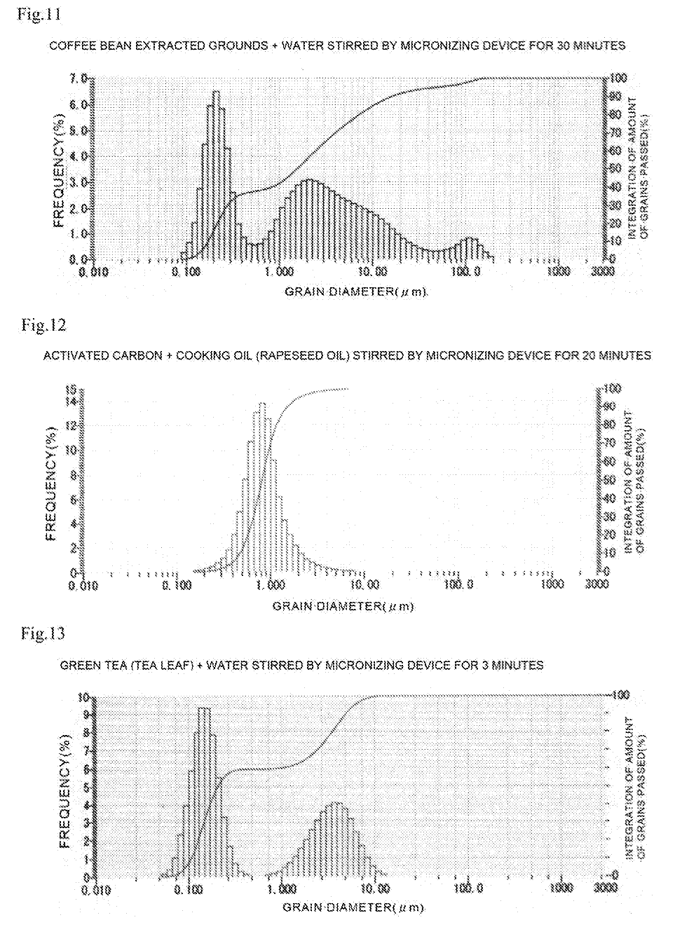

FIG. 11 illustrates a grain diameter distribution of a sample obtained after using coffee grounds (coffee bean extracted grounds) as the sample and stirring the sample with water by the micronizing device for 30 minutes. FIG. 12 illustrates a grain diameter distribution of a sample obtained after using activated carbon as the sample, and stirring the sample with cooking oil (rapeseed oil) by the micronizing device for 20 minutes. FIG. 13 illustrates a grain diameter distribution of a sample obtained after using green (tea leaves) as the sample and stirring the sample with water by the micronizing device for three minutes. In these cases, too, large grain diameter components of the processed sample processed by using the micronizing device decreased, and small grain diameter components increased.

### REFERENCE SIGNS LIST

1 micronizing device
2 case
2a pressuring member
2b case main body
3 suction port
4 suction pipe
5 suction chamber
6 delivery port
7 delivery pipe
8 vaned wheel
9 vane
10 vane plate
11 vane chamber
12 boss portion
12a through-hole
13 pump chamber
14 pressuring portion
15 pressuring chamber
16 partitioning wall
17 pressuring surface
18 pressure end point
θ vane sweepback angle (forward-inclining angle)
20a grinding surface
20b grinding surface
30 contact surface with boss portion
40 connection surface
41 fixing hole
42 connection surface
43 fixing hole

1. A micronizing device which micronizes a sample comprising:
a vaned wheel; and
a case which houses the vaned wheel, and includes a suction port which suctions in a pump chamber a fluid including the sample to be micronized, and a delivery port which delivers the fluid to an outside of the pump chamber, wherein
the vaned wheel includes a vane plate of a disk shape, a boss portion which pivotally supports rotatably on the case the vaned wheel provided at a center portion of the vane plate, and a plurality of vanes which protrudes in a radial pattern from the boss portion on a side surface of the vane plate, and includes a side end surface flush with the boss portion,
the case includes an inner circumferential surface of a cylindrical shape which houses the vaned wheel along an outer circumferential portion of the inner circumferential surface, and a pressuring portion which faces the vane of the vaned wheel housed in the case,
the pressuring portion includes a pressuring surface which faces the vane of the vaned wheel housed in the case, where the pump chamber which converges from a side of the suction port of the case to a side of the delivery port is formed between the pressuring surface and the vaned wheel, and a partitioning wall which partitions the pressuring surface to the side of the suction port of the case and a side at which the pump chamber converges, and includes a side end surface which comes into contact with a side end surface reaching the vane from the boss portion of the vaned wheel,
the positive displacement pump is configured to rotate the vaned wheel from the side of the suction port of the case to the side of the delivery port of the case opposite to the partitioning wall, transport the fluid including the sample to a rotation direction of the vaned wheel, pressure the fluid including the sample in the pump chamber which converges from the side of the suction port of the case to the side of the delivery port, and deliver the fluid through the delivery port of the case, and
a side end surface reaching the vane from the boss portion of the vaned wheel and a side end surface of the partitioning wall of the case include grinding surfaces, and the sample is micronized by way of grinding caused by rotation of the vaned wheel and by way of shearing caused by the vane of the vaned wheel on the grinding surfaces.

2. The micronizing device according to claim 1, wherein the grinding surfaces each include a groove of a lattice pattern formed by way of cutting.

3. The micronizing device according to claim 1, wherein the vane of the vaned wheel is bent such that a distal end side of the vane in a length direction warps inclining forward on the side end surface in the rotation direction of the vaned wheel.

4. The micronizing device according to claim 2, wherein the vane of the vaned wheel is bent such that a distal end side of the vane in a length direction warps inclining forward on the side end surface in the rotation direction of the vaned wheel.
